(19) United States
(12) Patent Application Publication
(10) Pub. No.: US 2016/0362988 A1
(43) Pub. Date: Dec. 15, 2016

(54) METHOD FOR MODIFYING AN AIRFOIL SHROUD AND AIRFOIL

(71) Applicant: General Electric Company, Schenectady, NY (US)

(72) Inventors: John David Ward, Woodruff, SC (US); Kelvin Rono Aaron, Simpsonville, SC (US); James Ryan Connor, Piedmont, SC (US); Melbourne James Myers, Woodruff, SC (US); Brad Wilson VanTassel, Easley, SC (US)

(21) Appl. No.: 15/245,985

(22) Filed: Aug. 24, 2016

Related U.S. Application Data
(63) Continuation-in-part of application No. 13/685,950, filed on Nov. 27, 2012, now abandoned.

(51) Int. Cl. F01D 5/22

(52) U.S. Cl. CPC F01D 5/225; F05D 2230/10; F05D 2220/32; F05D 2230/50

(57) ABSTRACT

A method is provided for modifying an airfoil shroud located at a tip of a blade of an airfoil, the airfoil shroud having a first end edge, a second end edge, a leading edge, and a trailing edge. The method includes locating a reference location in the first end edge of the airfoil shroud, the reference location including a portion of a seal rail extending circumferentially from a radially outer surface of the airfoil shroud, and a fillet extending from the radially outer surface and positioned directly adjacent to the seal rail. The method further includes forming a relief cut in the seal rail and fillet without performing a weld process on the airfoil shroud to remove the reference location, and installing the airfoil shroud in a turbomachine directly following forming the relief cut, wherein modifying the airfoil shroud is complete following forming the relief cut.

### CROSS-REFERENCE TO RELATED APPLICATION

This application is a continuation-in-part of co-pending U.S. patent application Ser. No. 13/685,950, filed on Nov. 27, 2012, which is hereby incorporated by reference in its entirety.

### BACKGROUND OF THE INVENTION

The subject matter disclosed herein relates to turbine engines. More particularly, the subject matter relates to modifying of turbine engine parts.

In a gas turbine engine, a compressor provides pressurized air to one or more combustors wherein the air is mixed with fuel and burned to generate hot combustion gas. These gases flow downstream to one or more turbines that extract energy therefrom to produce a mechanical energy output as well as power to drive the compressor. Over time, turbine parts, such as parts of the turbine, may experience fatigue, due to extreme conditions within the turbine, including high temperatures and pressures caused by flow of hot gas. In particular, certain turbine parts, such as buckets located on a turbine rotor, may experience fatigue that requires servicing or replacement.

In cases where reference locations in fatigued areas utilize welding or other heat-based operation, the repair process may further fatigue the local area. Thus, repair of some reference locations occurring due to wear and tear is not feasible. Replacement of these parts can be a costly, especially if fatigue in selected areas occurs in several parts, such as buckets on a rotor wheel.

### BRIEF DESCRIPTION OF THE INVENTION

According to one aspect of the invention, a method is provided for modifying an airfoil shroud located at a tip of an airfoil of a airfoil, the airfoil shroud having a first end edge, a second end edge, a leading edge and a trailing edge. The method includes locating a reference location in the first end edge of the airfoil shroud, the reference location being proximate a seal rail extending circumferentially from the substantially horizontal surface and forming a relief cut in the airfoil shroud to remove the reference location, wherein a modifying of the airfoil shroud is complete following forming of the relief cut.

According to another aspect of the invention, a bucket to be placed on a rotor of a turbine engine includes an airfoil having an airfoil axis, a shroud disposed at a tip of the airfoil, the shroud having a first end edge, a second end edge, a leading edge and a trailing edge, a seal rail extending circumferentially from a radially outer surface of the shroud and a recess formed in the first end edge proximate the seal rail and a trailing edge of the airfoil.

According to another aspect of the invention, a method is provided for modifying an airfoil shroud located at a tip of a blade of an airfoil, the airfoil shroud having a first end edge, a second end edge, a leading edge and a trailing edge. The method includes locating a reference location in the first end edge of the airfoil shroud, the reference location including a portion of a seal rail and a fillet, the seal rail extending circumferentially from a radially outer surface of the airfoil shroud, the fillet extending from the radially outer surface and positioned directly adjacent to the seal rail. The method also includes forming a relief cut in the seal rail and the fillet without performing a weld process on the airfoil shroud to remove the reference location, and installing the airfoil shroud in a turbomachine directly following forming the relief cut. Modifying the airfoil shroud is complete following forming the relief cut.

According to another aspect of the invention, a bucket includes an airfoil, a shroud, a seal rail, a fillet, and a recess. The airfoil has an airfoil axis. The shroud is disposed at a tip of the airfoil, and the shroud has a first end edge, a second end edge, a leading edge and a trailing edge. The seal rail extends circumferentially from a radially outer surface of the shroud. A fillet extends from the radially outer surface of the shroud and is positioned directly adjacent to the seal rail. A recess is formed in the first end edge of the shroud, such that the recess is formed within a portion of the seal rail and the fillet, and is positioned proximate to a trailing edge of the airfoil.

According to another aspect of the invention, a turbine engine includes a rotor and a bucket coupled with the rotor, the bucket including an airfoil, a shroud, a seal rail, a fillet, and a recess. The airfoil has an airfoil axis. The shroud is disposed at a tip of the airfoil, and the shroud has a first end edge, a second end edge, a leading edge, and a trailing edge. The seal rail extends circumferentially from a radially outer surface of the shroud. The fillet extends from a radially outer surface of the shroud and is positioned directly adjacent to the seal rail. The recess is formed in the first end edge of the shroud, such that the recess is formed within a portion of the seal rail and the fillet, and is positioned proximate to a trailing edge of the airfoil.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of an embodiment of a gas turbine system;

FIG. 2 is a side view of an embodiment of a airfoil having a shroud;

FIG. 3 is a top view of the airfoil of FIG. 2;

FIG. 4 is a top view of an embodiment of a airfoil shroud having a flaw;

FIG. 5 is a top view of the airfoil shroud shown in FIG. 4 with a relief cut to repair the flaw;

FIG. 6 is a top view of the airfoil shroud shown in FIG. 4 with an alternative relief cut to repair the flaw; and

FIG. 7 is a flow chart of an illustrative process for modifying an airfoil shroud according to various embodiments.

The detailed description explains embodiments of the invention, together with advantages and features, by way of example with reference to the drawings.

### DETAILED DESCRIPTION OF THE INVENTION

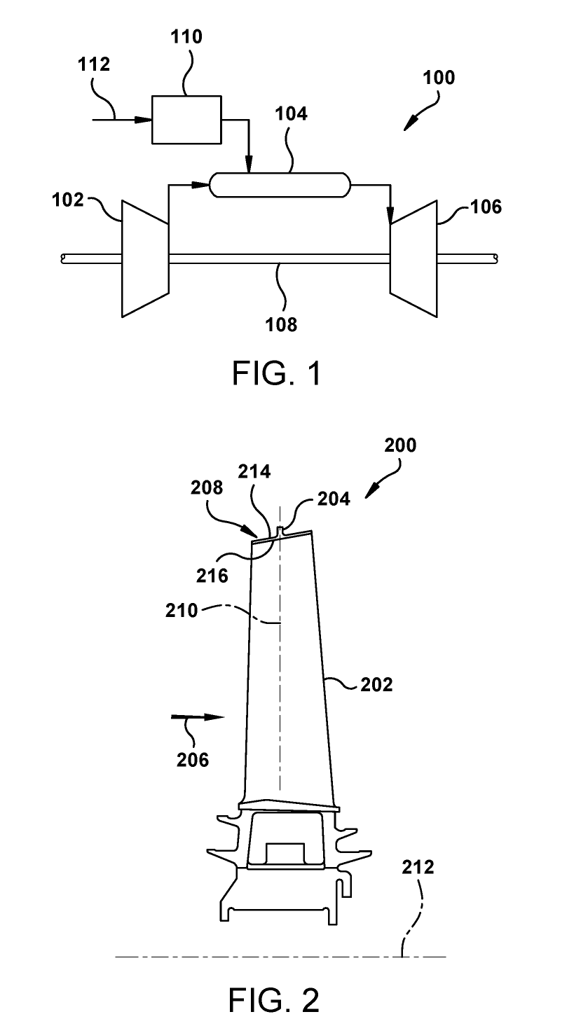

FIG. 1 is a schematic diagram of an embodiment of a gas turbine system 100. The system 100 includes a compressor 102, a combustor 104, a turbine 106, a shaft 108 and a fuel nozzle 110. In an embodiment, the system 100 may include a plurality of compressors 102, combustors 104, turbines 106, shafts 108 and fuel nozzles 110. As depicted, the compressor 102 and turbine 106 are coupled by the shaft 108. The shaft 108 may be a single shaft or a plurality of shaft segments coupled together to form shaft 108.

In an aspect, the combustor 104 uses liquid and/or gas fuel, such as natural gas or a hydrogen rich synthetic gas, to run the turbine engine. For example, fuel nozzles 110 are in fluid communication with a fuel supply 112 and pressurized air from the compressor 102. The fuel nozzles 110 create an air-fuel mix, and discharge the air-fuel mix into the combustor 104, thereby causing a combustion that creates a hot pressurized exhaust gas. The combustor 104 directs the hot pressurized exhaust gas through a transition piece into a rotor and stator assembly, causing turbine 106 rotation as the gas exits nozzles where the gas is then directed to the turbine buckets or blades. The rotation of the buckets coupled to the rotor in turbine 106 causes the shaft 108 to rotate, thereby compressing the air as it flows into the compressor 102.

In embodiments, a relief cut is formed in a shroud of a airfoil in the turbine engine. In an embodiment, the shroud is positioned on an airfoil such as a turbine bucket or a nozzle. The relief cut is formed to modify the shroud and remove a reference location in the airfoil shroud. In an embodiment, the reference location is a flaw, such as a crack, that has been identified on the shroud. The reference location may be caused by fatigue from exposure to extreme heat and pressure during turbine engine operation. In an embodiment, the relief cut is formed without welding the shroud, thus reducing incidence of additional fatigue that may be introduced to the shroud by a welding process. In one embodiment, the relief cut provides a structurally sound repair to the airfoil shroud to enable reuse and reinstallation of the airfoil following forming of the relief cut. Accordingly, the repair process provides savings in time and costs when servicing the airfoil.

As used herein, “downstream” and “upstream” are terms that indicate a direction relative to the flow of working fluid through the turbine. As such, the term “downstream” refers to a direction that generally corresponds to the direction of the flow of working fluid, and the term “upstream” generally refers to the direction that is opposite of the direction of flow of working fluid. In addition, the terms “leading edge” and “trailing edge” indicate a position of a part relative to the flow of working fluid. Specifically, a leading edge of an airfoil encounters hot gas flow before a trailing edge of the airfoil. The term “radial” refers to movement or position perpendicular to an axis or center line of a reference part or assembly. It may be useful to describe parts that are at differing radial positions with regard to an axis. In this case, if a first component resides closer to the axis than a second component, it may be stated herein that the first component is “radially inward” of the second component. If, on the other hand, the first component resides further from the axis than the second component, it can be stated herein that the first component is “radially outward” or “outboard” of the second component. The term “axial” refers to movement or position parallel to an axis. Finally, the term “circumferential” refers to movement or position around an axis. Although the following discussion primarily focuses on gas turbines, the concepts discussed are not limited to gas turbines and may apply to any suitable rotating machinery, including steam turbines. Accordingly, the discussion herein is directed to gas turbine embodiments, but may apply to steam turbines and other turbomachinery.

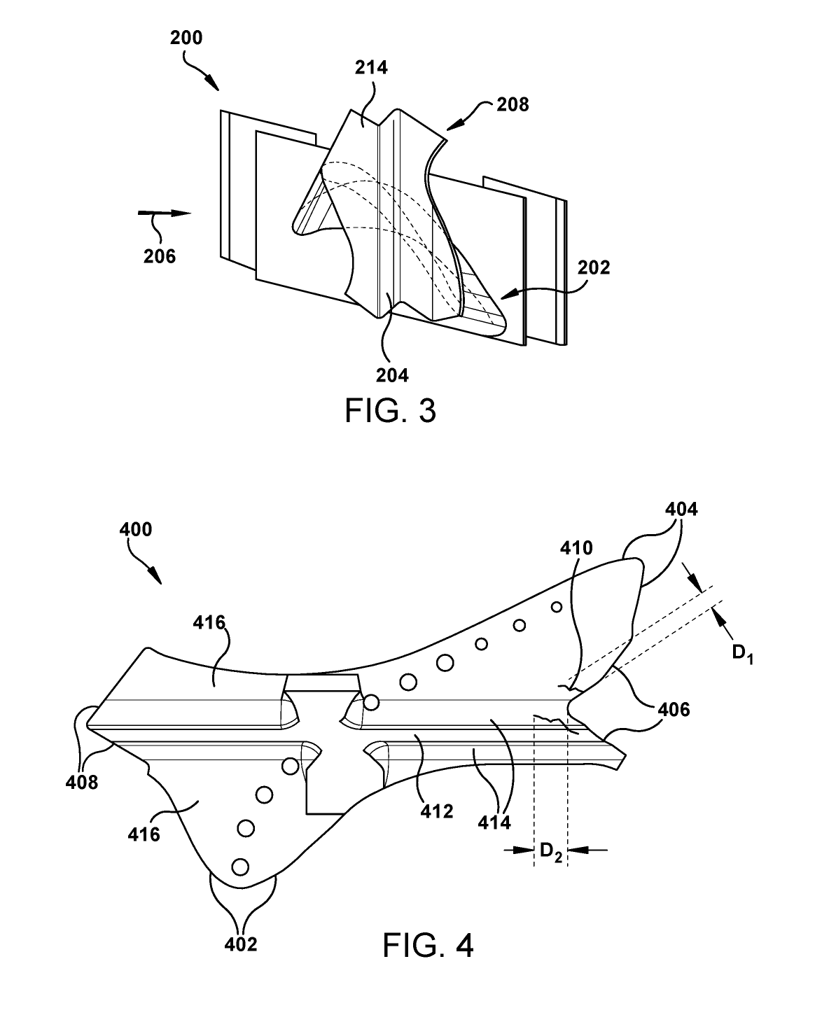

FIG. 2 is a side view of an airfoil 200 according to an embodiment. FIG. 3 is a top view of the airfoil 200 shown in FIG. 3. In embodiments, a plurality of airfoils 200 is coupled to a rotor wheel in a turbine engine assembly, such as the turbine engine system 100. The airfoil 200 includes a blade 202. In an embodiment, the blade 202 converts the energy of a hot gas flow 206 into tangential motion of the bucket, which in turn rotates the rotor to which the bucket is attached. At the top of the blade 202, a seal rail 204 is provided to prevent the passage of hot gas flow 206 through a gap between the bucket tip and the inner surface of the surrounding stationary components (not shown). As depicted, the seal rail 204 extends circumferentially from a surface of a radially outer side 214 of a shroud 208 located at the bucket tip. As depicted, the shroud 208 includes the radially outer side 214 and a radially inner side 216. In an assembly of buckets on a rotor, the seal rail 204 extends circumferentially around a bucket row on the rotor, beyond the airfoil 12 sufficiently to line up with seal rails provided at the tip of adjacent buckets, effectively blocking flow from bypassing the bucket row so that airflow must be directed to the working length of the blade 202. During operation, the bucket row and rotor rotate about rotor axis 212. In addition, an airfoil axis 210 extends longitudinally through the blade 202.

In embodiments, the shroud 208 is a flat plate supported towards its center by the blade 202, where the shroud 208 is subject to high temperatures and centrifugal loads during turbine operation. As a result, portions of the shroud 208 may experience fatigue over time, where embodiments of the modifying process described herein repair fatigue, such as reference locations in the airfoil shroud.

FIG. 4 is a top view of an embodiment of an airfoil shroud 400 disposed at a tip of an airfoil as described above. The airfoil shroud 400 has a leading edge 402, a trailing edge 404, a first end edge 406 and a second end edge 408 defining the shroud. A seal rail 412 extends from a radially outer side 416 of the shroud in a circumferential direction from the first end edge 406 to the second end edge 408. In a bucket row assembly for a rotor, the first end edge 406 is configured to be placed adjacent the second end edge 408 of an adjacent airfoil shroud to provide a substantially continuous circumferential seal rail assembly in the turbine stage. The circumferential seal rail assembly blocks hot gas flow (e.g., 206) from bypassing the bucket row so that flow is directed along a working length of the bucket airfoil.

The seal rail 412 has fillets 414 on each side extending from the radially outer surface 416 to provide support for the seal rail 412. During operation of the turbine engine, fatigue caused by high pressures and temperatures can cause formation of a reference location in the airfoil shroud 400, such as, but not limited to, first reference location 410 or second reference location 411. In an embodiment, the first reference location 410 is a crack proximate the fillet 414 of seal rail 412. At least a portion of the reference location 410 can be located a distance D₁ equal to or greater than 0.762 millimeters (approximately 0.03 inches) from a nearest portion of the first end edge 406 of the airfoil shroud 400. An alternative second reference location 411 is shown as a crack in the seal rail 412 and fillet 414. At least a portion of the second reference location 411 can be located a distance D₂ equal to or greater than 0.762 millimeters (approximately 0.03 inches) from a nearest portion of the first end edge 406 of the airfoil shroud 400. In cases such as these, where the first reference location 410 or the second reference location 411 is in or proximate a structural region, such as one or more of the fillets 414, or the seal rail 412, a relief cut may be used to repair and remove the reference location 410 or the reference location 411, as described below. The relief cut may be formed without performing a weld process on the shroud. In contrast, processes using welding to repair reference locations may adversely affect material structural regions of the airfoil shroud 400, such as fillets 414.

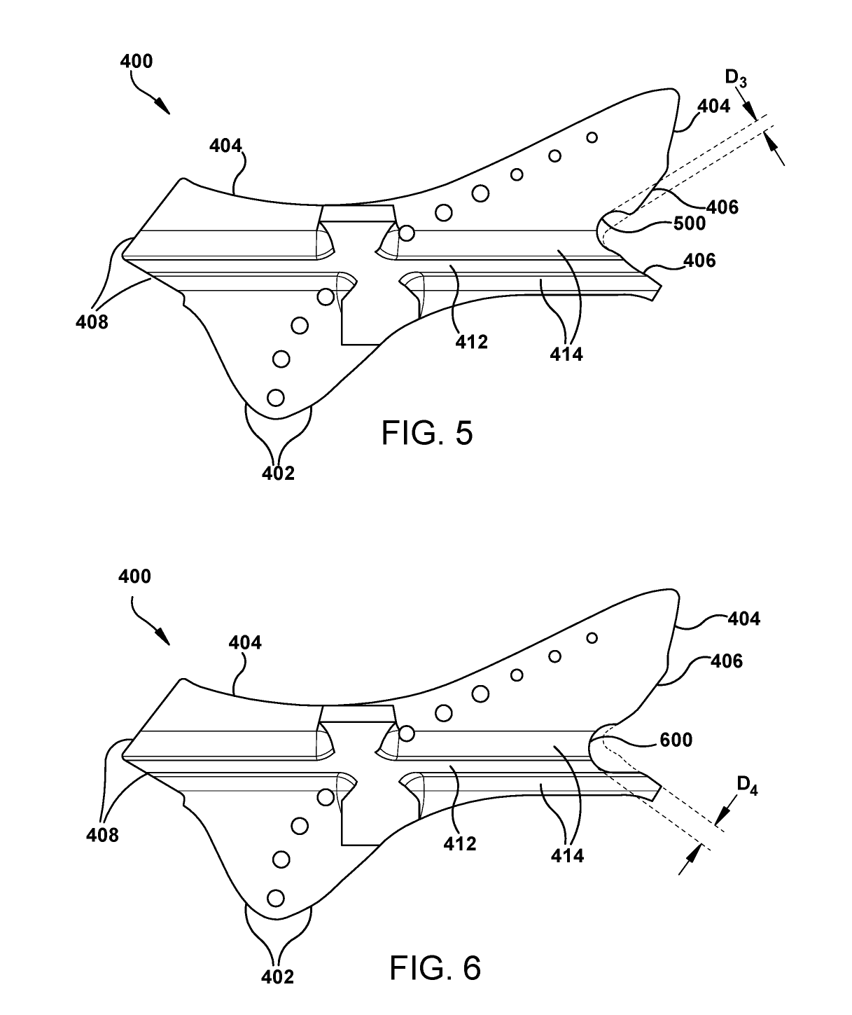

Accordingly, FIG. 5 is a top view of the airfoil shroud 400 following modifying the airfoil shroud. The method for modifying the airfoil shroud 400 includes locating the reference location 410 in the first end edge 406 of the shroud. The modifying also includes forming a relief cut 500 in the first end edge 406 proximate the fillet 414. At least a portion of the relief cut 500 can extend to a depth D₃ equal to or greater than 0.762 millimeters (approximately 0.03 inches) from the nearest portion of the first end edge 406 of the airfoil shroud 400 that was removed to form the relief cut 500. In an embodiment, the relief cut 500 forms an arc-shaped recess. In other embodiments, the relief cut 500 has any suitable geometry, such as a V-shape, parabolic, or polyhedron shape. The relief cut 500 may be formed using any suitable process, such as machining or drilling, to remove material including the reference location 410 from the airfoil shroud 400. In an embodiment, the airfoil shroud 400 is made from any suitable material, such as a steel alloy, stainless steel or other alloy.

FIG. 6 is a top view of the airfoil shroud 400 following an alternative approach for modifying the airfoil shroud 400. This method for modifying the airfoil shroud 400 includes locating the reference location 411 in the first end edge 406 of the shroud 400. The process can also include forming a relief cut 600 in the first end edge 406 in the seal rail 412 and the fillet 414 without performing a weld process on the airfoil shroud 400, to remove the reference location 411. At least a portion of the relief cut 600 can extend to a depth D₄ equal to or greater than 0.762 millimeters (approximately 0.03 inches) from the nearest portion of the first end edge 406 of the airfoil shroud 400 that was removed to form the relief cut 600. Modifying the airfoil shroud 400 can be complete following forming of the relief cut 600. In an embodiment, the relief cut 600 forms an arc-shaped recess. In other embodiments, the relief cut 600 has any suitable geometry, such as a V-shape, parabolic, or polyhedron shape. The relief cut 600 may be formed using any suitable process, such as machining or drilling, to remove material including the reference location 410 from the airfoil shroud 400. In an embodiment, the airfoil shroud 400 is made from any suitable material, such as a steel alloy, stainless steel or other alloy.

In embodiments, the modifying process services or repairs the airfoil shroud 400 without a welding process, thus ensuring structural integrity is maintained in the region repaired. The structural integrity provided by the relief cut 500, 600 enables the airfoil shroud 400 to be reinstalled in the bucket row of the rotor and to withstand loads and stress caused by extreme temperatures and pressures. By forming the arc-shaped relief cut 500, 600, the resulting geometry, including the fillet 414 and first end edge 406, maintains structural integrity to improve part life for the shroud, thus reducing operating costs for the turbine engine. In contrast, repair techniques that use a welding process may further fatigue the region being repaired. In some cases where welding is used for repair, welding may actually degrade the structural integrity of affected regions, thus leading to replacement of the entire airfoil and leading to increased operational costs. The service process utilizing the relief cut 500, 600 may be used to repair a reference location located in any suitable location, such as second end edge 408, leading edge 402 and trailing edge 404. In embodiments where the relief cut 500, 600 is in the first end edge 406, the relief cut 500, 600 may remove a portion of the fillet 414 without resulting in significant structural losses. In other embodiments, the relief cut 500, 600 is formed along a shroud edge and outside of the fillet 414. In cases where the relief cut 500, 600 forms an arc-shaped recess, a radius of the arc may vary depending on application needs.

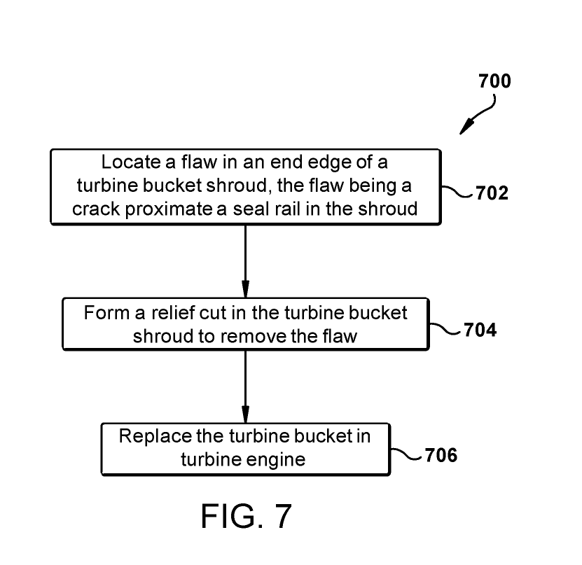

FIG. 7 is a flow chart of an exemplary process for modifying an airfoil shroud, such as airfoil shroud 400. In block 702, a reference location, such as a crack, is located in an end edge of an airfoil shroud, where the reference location is proximate a seal rail on the shroud. In embodiments, the reference location is on or proximate a fillet of the seal rail. In block 704, a relief cut is formed in the airfoil shroud surrounding the reference location, thus removing the reference location and repairing the shroud. In block 706, the airfoil with the repaired shroud is replaced in a turbine engine. In an embodiment, the airfoil is placed in a first or second stage of the turbine engine. In embodiments, the modifying process is complete after forming the relief cut, where the modifying does not include any welding of the shroud.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for modifying an airfoil shroud located at a tip of a blade of an airfoil, the airfoil shroud having a first end edge, a second end edge, a leading edge and a trailing edge, the method comprising:
locating a reference location in the first end edge of the airfoil shroud, the reference location including a portion of a seal rail and a fillet, the seal rail extending circumferentially from a radially outer surface of the airfoil shroud, the fillet extending from the radially outer surface and positioned directly adjacent to the seal rail;
forming a relief cut in the seal rail and the fillet without performing a weld process on the airfoil shroud to remove the reference location, wherein modifying the airfoil shroud is complete following forming the relief cut; and
installing the airfoil shroud in a turbomachine following forming the relief cut.

2. The method of claim 1, wherein at least a portion of the reference location is greater than 0.03 inches from a nearest portion of the first end edge of the airfoil shroud.

3. The method of claim 1, wherein forming the relief cut comprises forming a recess of a selected geometry in the first end edge of the airfoil shroud.

4. The method of claim 3, wherein forming the recess of the selected geometry comprises forming an arc-shaped recess.

5. The method of claim 1, wherein forming the relief cut comprises drilling the relief cut into the seal rail and the fillet.

6. A bucket comprising:
an airfoil having an airfoil axis;
a shroud disposed at a tip of the airfoil, the shroud having a first end edge, a second end edge, a leading edge and a trailing edge;
a seal rail extending circumferentially from a radially outer surface of the shroud;
a fillet extending from the radially outer surface of the shroud and positioned directly adjacent to the seal rail; and
a recess formed in the first end edge of the shroud, such that the recess is formed within a portion of the seal rail and the fillet, and is positioned proximate to a trailing edge of the airfoil.

7. The bucket of claim 6, wherein at least a portion of the recess extends from the first end edge of the airfoil shroud into the airfoil shroud a distance greater than 0.03 inches.

8. The bucket of claim 6, wherein the recess comprises a relief cut of a selected geometry.

9. The bucket of claim 8, wherein at least a portion of the relief cut extends to a depth greater than 0.03 inches from a nearest portion of the first end edge of the airfoil shroud removed to form the relief cut.

10. The bucket of claim 8, wherein the selected geometry comprises an arc-shaped recess.

11. The bucket of claim 10, wherein the arc-shaped recess is formed by drilling.

12. The bucket of claim 6, wherein the reference location is serviced without a welding operation.

13. The bucket of claim 6, wherein the bucket is configured to be placed in a second stage of the turbine engine.

14. A turbine engine comprising:
a rotor;
a bucket coupled with the rotor, the bucket comprising:
an airfoil having an airfoil axis;
a shroud disposed at a tip of the airfoil, the shroud having a first end edge, a second end edge, a leading edge and a trailing edge;
a seal rail extending circumferentially from a radially outer surface of the shroud;
a fillet extending from the radially outer surface of the shroud and positioned directly adjacent to the seal rail; and
a recess formed in the first end edge of the shroud, such that the recess is formed within a portion of the seal rail and the fillet, and is positioned proximate to a trailing edge of the airfoil.

15. The turbine engine of claim 14, wherein the recess extends from the first end edge of the airfoil shroud into the airfoil shroud a distance greater than 0.03 inches.

16. The turbine engine of claim 14, wherein the recess comprises an arc-shaped relief cut.

17. The turbine engine of claim 16, wherein at least a portion of the relief cut extends to a depth greater than 0.03 inches from a nearest portion of the first end edge of the airfoil shroud removed to form the relief cut.

18. The turbine engine of claim 16, wherein the arc-shaped relief cut is formed by machining.

19. The turbine engine of claim 14, wherein the reference location is serviced without a welding operation.

20. The turbine engine of claim 14, wherein the bucket is located in a second stage of the turbine engine.
